(19) United States
(12) Patent Application Publication
(10) Pub. No.: US 2003/0019702 A1
(43) Pub. Date: Jan. 30, 2003

(54) Device for activating a parking brake

(75) Inventors: Tobias Goedecke, Kernen (DE); Carsten Haertel, Fellbach (DE)

Correspondence Address: CROWELL & MORING LLP, INTELLECTUAL PROPERTY GROUP, P.O. BOX 14300, WASHINGTON, DC, 20044-4300, US

(73) Assignee: DaimlerChrysler AG.

(21) Appl. No.: 10/200,222

(22) Filed: Jul. 23, 2002

(30) Foreign Application Priority Data
Jul. 26, 2001 (DE) 101 36 425.3

(51) Int. Cl. B60T 11/00

(52) U.S. Cl. 188/353

(57) ABSTRACT

A device for activating a parking brake includes a hydraulic cylinder-piston unit and a pressure source. The hydraulic cylinder-piston unit is operatively connected to the parking brake to activate the parking brake. The pressure source supplies pressure medium to the hydraulic cylinder-piston unit, wherein the cylinder-piston unit is configured to have pressure medium applied to both sides of the piston of the hydraulic cylinder-piston unit.

This application claims the priority of German Patent Document No. 101 36 425.3, filed Jul. 26, 2001, the disclosure of which is expressly incorporated by reference herein.

The invention relates to a device for activating a parking brake.

DE 41 27 991 C2 discloses a device of the generic type for activating a parking brake of a motor vehicle. The device has a hydraulic cylinder piston unit which can be connected to a pump via a solenoid valve. A piston of the cylinder piston unit is operatively connected via an activation linkage to the parking brake to activate it.

The piston is loaded in the direction of its first limit position using a helical spring and can be loaded in the direction of its second limit position using pressure medium from the pump against the spring force of the helical spring. If there is no pressure medium at the piston, the piston is held in its first limit position by the helical spring and the parking brake is engaged. If the piston has pressure medium applied to it, the piston is displaced to its second limit position against the helical spring, and the parking brake is released.

In order to be able to hold the parking brake in a released position for a limited period of time when the pump is switched off, a pressure medium accumulator is arranged upstream of the unit.

The invention is based in particular on an object of making available a device in which unintended activation can be reliably avoided. It is achieved according to the embodiments of the invention as described hereinafter.

The invention is based on a device for activating a parking brake, in particular, of a motor vehicle having a hydraulic cylinder-piston unit which is operatively connected to the parking brake to activate it, and having a pressure source.

The cylinder-piston unit can have pressure applied to it on both sides and/or have a double-acting cylinder. As a result, unintentional activation, caused by, for example, a drop in pressure, can be reliably avoided. In addition, the cost of a spring can be avoided, and the cylinder-piston unit can be actuated and secured in its limit position with low pressure. As a result, the pressure source can be made small, less costly, and energy efficient.

If the cylinder-piston unit can be connected to a pressure accumulator, the parking brake can be repeatedly engaged and disengaged when the pump is switched off. In addition, undesired influences of pressure fluctuations on the parking brake can at least be largely avoided.

In a preferred embodiment of the invention, the activation of the parking brake can be controlled by a control unit as a function of at least one sensed operating parameter. Further safety functions can be set up and incorrect switching operations avoided. In particular it is possible to reliably avoid a situation in which the parking brake is engaged above a certain speed and there is thus the so-called ratcheting of the parking brake. The parking brake can be configured in a space-saving and cost-effective way. In addition, a partially automated or even a fully automated activation of the parking brake can be achieved so that, for example, the parking brake is automatically engaged when the motor vehicle is parked and automatically released when it is started up. The operating parameters may include, for example, by accelerator pedal position, the position of an ignition key, driving speed, inclination of the vehicle, etc.

If the control unit is integrated at least partially with a gearbox control unit, there can be a saving in terms of additional components, installation space, mounting work and costs, and interfaces for transmitting operating parameters into a separate control unit can be avoided. In addition, there can be a saving in terms of additional components in that the pressure source is formed by a motorized gear pump.

If the parking brake has assumed the desired position or if a sufficient pressure level has been reached in the pressure accumulator, the pressure medium can be fed into a tank by the pump, for example via an overpressure valve. However, if a shut-off valve is connected downstream of the pump, the pump can simply be switched off or disconnected and energy can be saved.

In a further embodiment of the invention, the pressure source includes a pump which is separate from a motorized gear pump. The pump (the pressure source) can be configured selectively for one function, and a particularly precise, flexible and energy-saving way of actuating a parking brake can be implemented. In addition, the additional pump can advantageously be used for supporting the motorized gear pump or another pump, specifically in that it can be operatively connected to at least one further hydraulic system and can be used to support at least one further pump. The pump can be driven by a drive unit which is already present, or by an additional drive unit.

In principle it is conceivable that when the motor vehicle is switched off the cylinder-piston unit is held in a limit position solely by a pressure which continues to prevail in the system. As already stated, only a low pressure is necessary to activate and secure the cylinder-piston unit in a limit position. However, if the parking brake can be secured at least in its engaged position by a securing device, the parking brake can be particularly reliably prevented from being released, in a structurally simple way, even when the motor vehicle is switched off for a relatively long time. In order, nevertheless, to ensure that the motor vehicle operates when the securing device is defective, the securing device is advantageously configured in such a way that the parking brake can be moved counter to a securing force of the securing device by the pressure source and/or by a pressure accumulator via the cylinder-piston unit.

The securing device can be a latching device or some other device which appears appropriate to a person skilled in the art. However, if the securing device has a positioning actuator, large securing forces can advantageously be achieved and securing forces can at least largely be avoided during the activation of the parking brake.

In addition, the position of the cylinder-piston unit is monitored by at least one limit position switch, as a result of which simple control can be achieved. In addition, when a limit position is detected, the pressure in the cylinder-piston unit and/or a driving power, for example, a pump of the pressure source, can be reduced to save energy.

If the cylinder-piston unit is connected to the parking brake via at least one balancing clutch, it is easily possible to compensate, in particular, axial offset between the cylinder-piston unit and the parking brake, and reliably avoid jamming.

Further advantages emerge from the following description of the drawing. Exemplary embodiments of the invention are illustrated in the drawing. The description and the claims contain numerous features in combination. The person skilled in the art will also expediently consider the features individually and combine them to form further appropriate combinations.

### BRIEF DESCRIPTION OF THE DRAWINGS

FIG. 1 shows a schematically illustrated device with a pressure source formed by a motorized gear pump, and

FIG. 2 shows a device which is an alternative to FIG. 1 and has a pump driven by an electric motor.

### DETAILED DESCRIPTION OF THE DRAWINGS

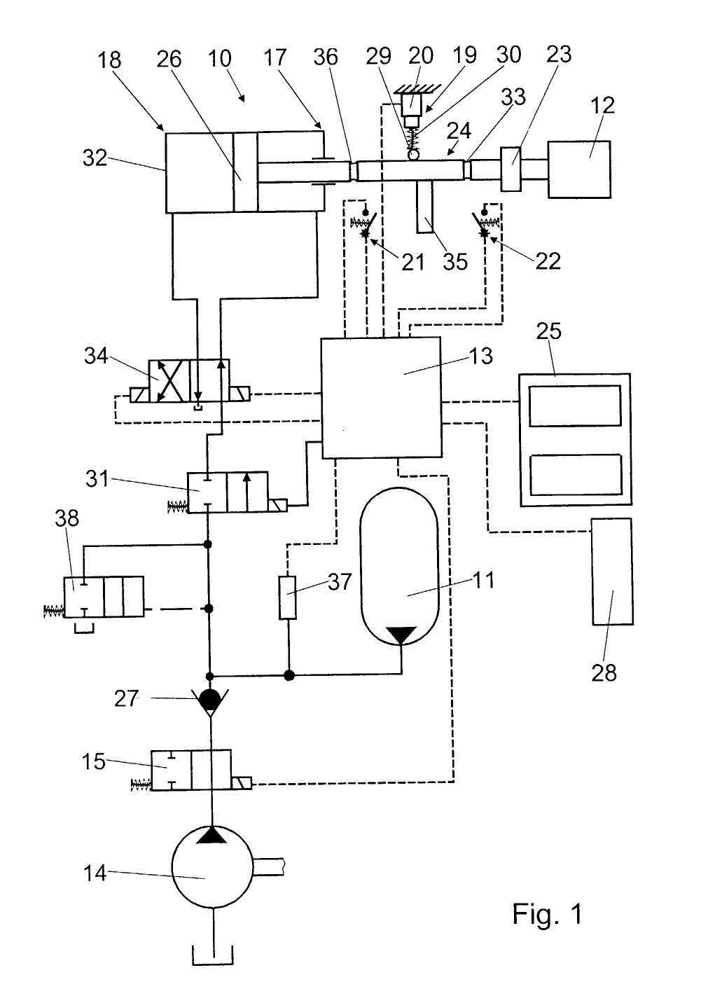

FIG. 1 shows a schematic view of a device according to the invention for activating a parking brake 12 of a motor vehicle. The device has a hydraulic cylinder-piston unit 10 which is operatively connected to the parking brake 12 to activate it via an activation linkage 24 and via a balancing clutch 23 which compensates an axial offset. The device has a pressure source which is formed by a motorized gear pump 14 and which is driven by an internal combustion engine of the motor vehicle. According to the invention, the cylinder-piston unit 10 can have pressure applied to it on both sides.

The pressure necessary to activate a piston 26 of the cylinder-piston unit 10 is provided by a hydraulic accumulator 11, which can be connected to the motorized gear pump 14 via a leak-free non-return valve 27 and via a shut-off valve 15. The shut-off valve 15 is formed by a 2/2-way valve which can be activated electromagnetically against a restoring spring and which has continuous flow in the neutral position.

An operator of the motor vehicle can input, using an operator control 25, whether the parking brake 12 is to be engaged or released. A corresponding signal being passed on to a control unit 13 which is embodied in one piece with a gearbox control unit. In addition, the control unit 13 is connected to a sensor unit 28. If an ignition key of the motor vehicle is withdrawn, the parking brake 12 is automatically engaged via the control unit 13. If a specific accelerator pedal position is exceeded after the motor vehicle starts, the parking brake 12 is automatically released. In addition, engagement of the parking brake 12 is prevented at a driving speed higher than a limiting speed. The limiting speed may be, for example, eight kilometers per hour. It must be at least so high that it can be reliably measured by a control unit (not illustrated).

In order to displace the piston 26 out of its first limit position 17, assigned to a parked position “P”, into its second limit position 18 assigned an operating position “D”, “N” and “R”, a securing device 19 is released by the control unit 13. In the process, an electromagnetic actuator 20 of the securing device 19 is briefly energized, thus briefly removing the loading from a prestressed helical spring 30 which acts on a latching ball 29. At the same time, a switch-over valve 34 and a switching valve 31 are activated by the control unit 13, as a result of which pressure from the hydraulic accumulator 11 is applied to a cylinder 32 of the cylinder-piston unit 10 on the side facing the parking brake 12, and it is pressure-relieved on the side facing away from the parking brake 12. The switching valve 31 is formed by a 2/2-way valve which can be electromagnetically activated counter to a restoring spring and has a continuous flow in the neutral position, and the switch-over valve is formed by a 4/2-way valve which can be electromagnetically activated in both switched positions.

The piston 26 is displaced into its second limit position 18 and the parking brake 12 released. In the second limit position 18, the latching ball 29 latches into a first recess 33 in the activation linkage 24, and the parking brake 12 is locked in its released position. Via a first limit position switch 21, which is activated by a switching pin 35 attached to the activation linkage 24, it is signalled to the control unit 13 that the second limit position 18 has been reached.

In order to move the piston 26 out of its second limit position 18 into its first limit position 17, the actuator 20 is briefly energized and the helical spring 30 relieved of loading. At the same time, the switch-over valve 34 and the switching valve 31 are activated by the control unit 13. As a result of which the cylinder 32 is relieved of loading on the side facing the parking brake 12, and pressure is applied to it from the hydraulic accumulator 11 on the side facing away from the parking brake 12. The piston 26 is displaced into its first limit position 17, and the parking brake 12 is engaged. In the first limit position 17, the latching ball 29 latches into a second recess 36 in the activation linkage 24, and the parking brake 12 is locked in its engaged position. Via a second limit position switch 22, which is activated by the switching pin 35 attached to the activation linkage 24, it is signalled to the control unit 13 that the first limit position 17 has been reached.

The pressure in the hydraulic accumulator 11 is monitored by means of a pressure sensor 37. When a specific pressure is reached in the hydraulic accumulator 11, a signal is transmitted by the pressure sensor 37 to the control unit 13 which causes the shut-off valve 15 to interrupt the supply of pressurized medium to the hydraulic accumulator 11. A maximum permissible pressure is prevented from being exceeded with a pressure-limiting valve 38 which is formed by a 2/2-way valve which can be activated counter to a restoring spring and has continuous flow in the neutral position.

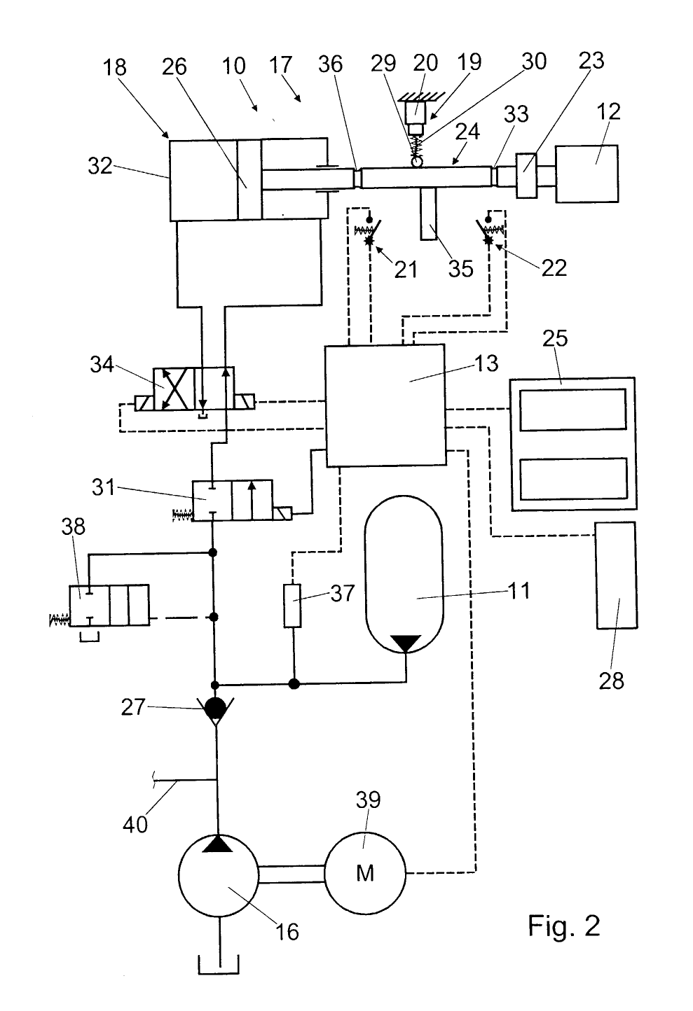

FIG. 2 illustrates an alternative embodiment of the present invention. Components, which are essentially the same, are provided with identical reference numbers. In addition, with respect to features and functions which are the same, reference is made to the description relating to the exemplary embodiment in FIG. 1. The following description is restricted essentially to the differences from the exemplary embodiment in FIG. 1.

A hydraulic accumulator 11 is filled with pressure medium with a pump 16 which is separated from a motorized gear pump. The pump 16 is driven by an electric motor 39. The pressure in the hydraulic accumulator 11 is monitored by a pressure sensor 37. When a specific pressure is reached in the hydraulic accumulator 11, a signal is transmitted via the pressure sensor 37 to the control unit 13 which switches off the electric motor 39.

In order to support a further pump (not illustrated), the pump 16 can be operatively connected via a line 40 to a further hydraulic system (not illustrated).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed

1. A device for activating a parking brake, the device comprising:
a hydraulic cylinder-piston unit operatively connected to the parking brake to activate the parking brake, the hydraulic cylinder-piston unit having a piston; and
a pressure source supplying pressure medium to the hydraulic cylinder-piston unit, wherein the cylinder-piston unit is configured to have pressure medium applied to both sides of the piston of the hydraulic cylinder-piston unit.

2. The device according to claim 1, further comprising a pressure accumulator, wherein the cylinder-piston unit is connected to the pressure accumulator.

3. The device according to claim 1, further comprising a control unit, wherein the control unit controls the activation of the parking brake as a function of at least one sensed operating parameter.

4. The device according to claim 3, wherein the control unit is integrated at least partially with a gearbox control unit.

5. The device according to claim 1, wherein the pressure source includes a motorized gear pump.

6. The device according to claim 5, further comprising a shut-off valve, wherein the shut-off valve is disposed downstream of the motorized gear pump.

7. The device according to claim 1, wherein the pressure source includes a pump which is separated from a motorized gear pump.

8. The device according to claim 7, wherein the pump is operatively connectable to at least one further hydraulic system and can be used to support at least one further pump.

9. The device according to claim 1, further comprising a securing device, wherein the parking brake is securable in its engaged position by the securing device.

10. The device according to claim 9, wherein the securing device has an actuator.

11. The device according to claim 1, further comprising a limit position switch, wherein the limit position switch monitors the position of the piston of the cylinder-piston unit.

12. The device according to claim 1, further comprising a balancing clutch, wherein the cylinder-piston unit is connected to the parking brake via the balancing clutch.

13. A method for making a device for activating a parking brake, the method comprising:
connecting a hydraulic cylinder-piston unit to the parking brake to activate the parking brake; and
connecting a pressure source to the hydraulic cylinder-piston unit to supply pressure medium to the hydraulic cylinder-piston unit, wherein the hydraulic cylinder-piston unit is configured to have pressure medium applied to both sides of the piston of the hydraulic cylinder-piston unit.

14. The method according to claim 13, further comprising connecting a pressure accumulator to the cylinder-piston unit.

15. The method according to claim 13, further comprising providing a control unit, wherein the control unit controls the activation of the parking brake as a function of at least one sensed operating parameter.

16. The method according to claim 15, further comprising at least partially integrating the control unit with a gearbox control unit.

17. The method according to claim 13, wherein the pressure source includes a motorized gear pump.

18. The method according to claim 17, further comprising a shut-off valve, wherein the shut-off valve is disposed downstream of the motorized gear pump.

19. The method according to claim 13, wherein the pressure source includes a pump which is separated from a motorized gear pump.

20. The method according to claim 19, further comprising connecting the pump to at least one further hydraulic system and can be used to support at least one further pump.

21. The method according to claim 13, further comprising providing a securing device to secure the parking brake in its engaged position.

22. The method according to claim 21, wherein the securing device has an actuator.

23. The method according to claim 13, further comprising providing a limit position switch to monitor the position of the piston of the cylinder-piston unit.

24. The method according to claim 13, further comprising providing a balancing clutch, and connecting the cylinder-piston unit to the parking brake via the balancing clutch.
